(19) United States
(12) Patent Application Publication
(10) Pub. No.: US 2024/0262201 A1
(43) Pub. Date: Aug. 8, 2024

(54) METHODS FOR OPTIMIZING INFORMATION DISPLAYS INSIDE AUTOMOBILE CLUSTER DISPLAYS

(71) Applicant: GOOGLE LLC, Mountain View, CA (US)

(72) Inventors: Imran Pirwani, Mountain View, CA (US); Rob McAuliffe, Mountain View, CA (US)

(21) Appl. No.: 18/017,012

(22) PCT Filed: Feb. 23, 2022
(86) PCT No.: PCT/US22/17435

§ 371 Date: Jan. 19, 2023

Related U.S. Application Data
(60) Provisional application No. 63/295,126, filed on Dec. 30, 2021.

(51) Int. Cl. B60K 35/29; B60K 35/60; B60K 35/81; G06F 3/14

(52) U.S. Cl. CPC B60K 35/29; B60K 35/60; B60K 35/81; G06F 3/14; B60K 2360/139; B60K 2360/166; B60K 2360/1868; B60K 2360/698

(57) ABSTRACT

A computing device may implement a method for optimizing data display placement within display units. The method includes obtaining dimensions of an available display area within a display unit, and determining an irregular shape representative of the available display area based on the dimensions. The method further includes generating a second shape that is representative of a data display, wherein the second shape is smaller than the irregular shape, and translating the second shape within the irregular shape until the second shape is at a location within the irregular shape. All edges of the second shape are contained within the irregular shape at the location. The method further includes rendering the data display at the location within the available display area.

### CROSS-REFERENCE TO RELATED APPLICATION

This application claims priority to U.S. Provisional Application Ser. No. 63/295,126, which was filed on Dec. 30, 2021, and is titled “Methods for Optimizing Information Displays Inside Automobile Cluster Displays”, the entirety of which is expressly incorporated herein by reference.

### FIELD OF THE DISCLOSURE

The present disclosure relates to cluster displays and, more particularly, to methods for optimizing data displays inside of automobile instrument cluster displays.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, vehicle instrument clusters must make information easily digestible for drivers and passengers, so as not to distract from the driving of the vehicle. In order to minimize the confusion/distraction caused by such instrument clusters, vehicle/application designers typically desire to effectively utilize all or as much of the available display area as possible. For example, effective utilization of the available display area is critical while displaying a map to enable a user to quickly and efficiently determine navigation instructions necessary for the user to reach their destination safely.

Further, with the advent of digital instrument clusters, vehicle information is typically dynamically presented within such instrument clusters in a variety of formats and densities, as the available display area may not be statically defined. Moreover, digital applications configured to render user interfaces and/or other displays on these instrument clusters may each utilize different amounts of the available display area. In all, this dynamic presentation capability can cause significant challenges when attempting to determine and utilize the entire available display area, especially in view of the curved edges display units typically have within vehicles. These issues are further compounded because vehicle instrument clusters typically have irregularly-shaped cutouts for a speedometer and similar information displays, leaving irregularly-shaped spaces for general information use.

As a result, such conventional display units and corresponding digital applications are highly inefficient when placing information displays (also referenced herein as “widgets”, or “content” or “data displays”) within an available display area. Conventional display systems define a rectangular “safe area” within a statically-defined portion of the display area where a rectangular grid-based layout can be used to place such widgets within the statically-defined portion. While this enables such conventional systems to place information displays within the display area, the irregularly-shaped border areas are generally completely ignored, and a considerable amount of the statically-defined portion of the display area is obscured by the information displays. Referencing the prior example, a conventional system may display a speed limit widget corresponding to a current roadway over a portion of the map application providing the user with navigation directions, thereby obscuring the map application and interfering with the user's ability to safely navigate to their destination.

Thus, in general, conventional information display units and corresponding applications configured to display on such units fail to provide users with intelligently placed information displays that effectively utilize available display area while minimally obscuring other information rendered on such display units.

### SUMMARY

Using the techniques of this disclosure, a user's computing device may automatically adjust the placement of data displays inside of an available display area within a display unit in order to avoid the data displays from being obfuscated and/or otherwise not viewable by a user while simultaneously maximizing the use of the available display area. The techniques of the present disclosure utilize the dimensions of the available display area in tandem with an input vector and shapes meant to represent data displays to determine optimal placements of the data displays by calculating a furthest location in the direction of the input vector where the representative shapes may be placed such that the entire data display is contained within the available display area. For example, the available display area in a vehicle may display directions as part of a mapping application that a user is following to reach a destination, and a data display displaying the speed limit of the current road on which the user is traveling may be displayed as part of the mapping application on the available display area. The techniques of the present disclosure may optimally place the speed limit widget in a corner of the available display area to avoid covering critical information from the mapping application (e.g., directions, POIs, etc.) while still providing the user with the relevant speed limit.

In particular, vehicle car displays must make information easily digestible by the user, so as not to distract from the more important task of driving a vehicle. Displaying information generally necessitates using all of the screen real-estate effectively, including the behind-the-steering-wheel instrument cluster (“the cluster”). This applies especially to displaying a map for navigation purposes. However, using the full screen space of the cluster is challenging given that, in many instances, the cluster has curved edges, resulting in irregular shaped cutouts for the speedometer and other cluster readouts (e.g., RPMs, fuel gauge, temperature, etc.). The present techniques overcome these challenges experienced by conventional systems by determining the feasible placement areas for data displays within an available display area based on the dimensions of the available display area. Of course, it should be understood that the example embodiment of a vehicle cluster is referenced herein for ease of discussion only. The present techniques are suitable for any displays that leave non-rectangular and/or otherwise abnormal spaces for data use/display.

In certain aspects, the techniques of the present disclosure may overcome the issues experienced by conventional systems using an efficient algorithm that determines an optimal placement for each data display. Namely, the algorithm may perform several actions, including: obtaining dimensions of an available display area within a display unit and a two-dimensional (2D) input vector that includes an input direction; determining a first shape representative of the available display area based on the dimensions; generating a shape that is representative of a data display; and translating the shape within the first shape until the shape is at a furthest point relative to the input direction that is within the first shape, wherein all edges of the shape are contained within the first shape at the furthest point.

In general, the furthest point may be calculated as part of the algorithm based on an objective function that may be calculated over all feasible solutions for the data display. A feasible solution corresponds to any placement of the data display wherein the widget is contained within the available display area. Thus, the furthest point for a particular data display generally corresponds to a placement within the display unit that is furthest in the direction of the input vector while the data display is still contained within the available display area. In any event, once the furthest point is determined for a particular data display, the algorithm may include rendering the data display in the available display area for display to a user.

In this manner, aspects of the present disclosure provide a technical solution to the problem of obfuscated, not viewable, and/or otherwise non-optimally placed data displays within an available display area within a display unit by automatically determining an optimal placement for information displays based on the dimensions of the available display area. Conventional systems may include data displays located at a pre-defined location on the available display area, but are typically incapable of actively determining optimal placements for such widgets as the data displayed in the available display area changes and/or otherwise causes the predefined location unsuitable for use displaying data displays. Consequently, conventional systems are unable to provide optimal placement locations for data displays within an available display area within a display unit, and generally lack the ability to provide a user with an ideal amount of relevant information. As a result, conventional systems typically frustrate users by either providing an insufficient amount of information when widgets are not shown, and/or by obfuscating the data displayed as part of an application (e.g., mapping application) which the user would prefer to view instead of the overlaid data display. By contrast, the techniques of the present disclosure eliminate these frustrating, uninformative interactions with applications displayed on a display unit by providing intelligently placed data displays that ensure users have quick and easy access to all relevant data displayed on the available display area of the display unit.

Moreover, using the techniques of the present disclosure, the user's chosen mapping application (e.g., GOOGLE MAPS, etc.) may more optimally utilize the available space on a display screen. Conventional techniques utilize a predefined area within the display screen (e.g., a rectangle in the center of the display screen) to place data displays as a default, where the widgets may obscure data of the underlying application and/or may be limited in their size/amount due to the restricted nature of the predefined area. The techniques of the present disclosure overcome these issues by considering/utilizing the entire available area of the display screen in order to provide an optimal amount of data without sacrificing the overall display capacity of the underlying application. As a result, the present techniques provide a more efficient use of available display screen space that maximizes data display capacity relative to conventional techniques

One example embodiment of the techniques of this disclosure is a method in a computing device for optimizing data display placement within display units. The method includes obtaining, by one or more processors of the computing device, dimensions of an available display area within a display unit that includes an input direction; determining, by the one or more processors, a first shape representative of the available display area based on the dimensions; generating, by the one or more processors, a second shape that is representative of a data display, wherein the second shape is smaller than the first shape; translating, by the one or more processors, the second shape within the first shape until the second shape is at a furthest point relative to the input direction that is within the first shape, wherein all edges of the second shape are contained within the first shape at the furthest point; and rendering, by the one or more processors, the information display at the furthest point within the available display area

Another example embodiment of the techniques of the present disclosure is a computing device for optimizing data display placement within display units. The computing device includes one or more processors and a computer-readable memory which may be non-transitory, coupled to the one or more processors. The memory stores instructions thereon that, when executed by the one or more processors, cause the computing device to: obtain dimensions of an available display area within a display unit and an input direction, determine a first shape representative of the available display area based on the dimensions, generate a second shape that is representative of a data display, translate the second shape within the first shape until the second shape is at a furthest point relative to the input direction that is within the first shape, wherein all edges of the second shape are contained within the first shape at the furthest point, and render the data display at the furthest point within the available display area.

Yet another example embodiment of the techniques of the present disclosure is a method in a computing device for optimizing data display placement within display units. The method includes obtaining, by one or more processors of the computing device, dimensions of an available display area within a display unit, the available display area represented by an irregular shape; obtaining, by the one or more processors, a data display; placing, by the one or more processors, the data display within the available display area along a border of the irregular shape; and presenting, by the one or more processors, the information display within the available display area.

### BRIEF DESCRIPTION OF THE DRAWINGS

FIG. 1A is a block diagram of an example communication system in which techniques for optimizing information displays inside of automobile cluster displays can be implemented;

FIG. 1B illustrates an example automobile environment in which the techniques of the present disclosure can be used to optimize information displays inside of an automobile cluster display;

FIG. 2 illustrates an example placement of a set of information displays utilizing the information display placement module of FIG. 1A, in accordance with embodiments herein;

FIGS. 3A-D illustrate an example information display placement sequence utilizing portions of the example communication system of FIG. 1A, in accordance with embodiments herein;

FIG. 4 illustrates an example placement of a set of information displays within a divided display unit area of a display unit utilizing multiple input directions, in accordance with embodiments herein;

FIG. 5 illustrates an example placement of a set of information displays within a display unit area of a display unit featuring several holes utilizing multiple input directions, in accordance with embodiments herein;

FIGS. 6A-C illustrate an example placement sequence of a set of information displays within a dynamically adjusting display unit area of a display unit, in accordance with embodiments herein;

FIG. 7 illustrates an example translation sequence of an information display along an edge of an available display area of a display unit to determine feasible placement regions for the information display within the available display area, in accordance with embodiments herein;

FIGS. 8A-D illustrate an example translation sequence of an information display along a vertex of an available display area of a display unit to determine feasible placement regions for the information display within the available display area, in accordance with embodiments herein;

FIG. 9 is a flow diagram of an example method for optimizing information displays inside of automobile cluster displays, which can be implemented in a computing device, such as the user computing device of FIG. 1A.

### DETAILED DESCRIPTION

### Overview

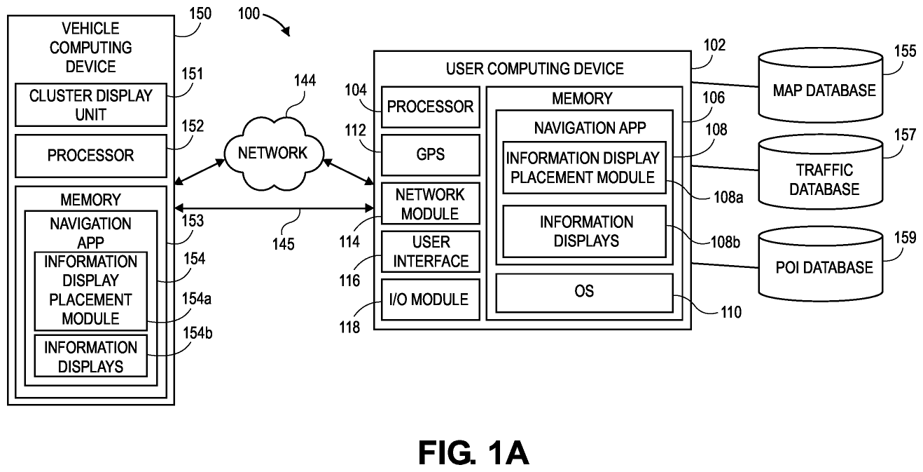

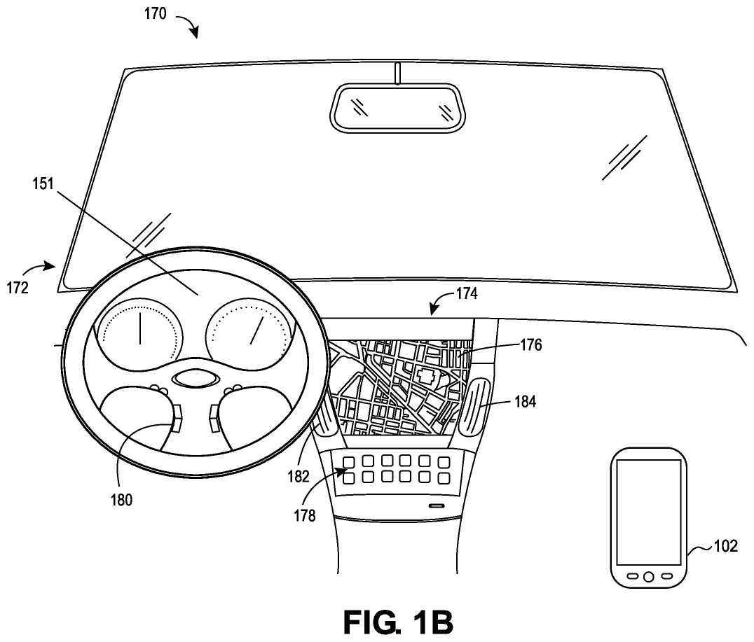

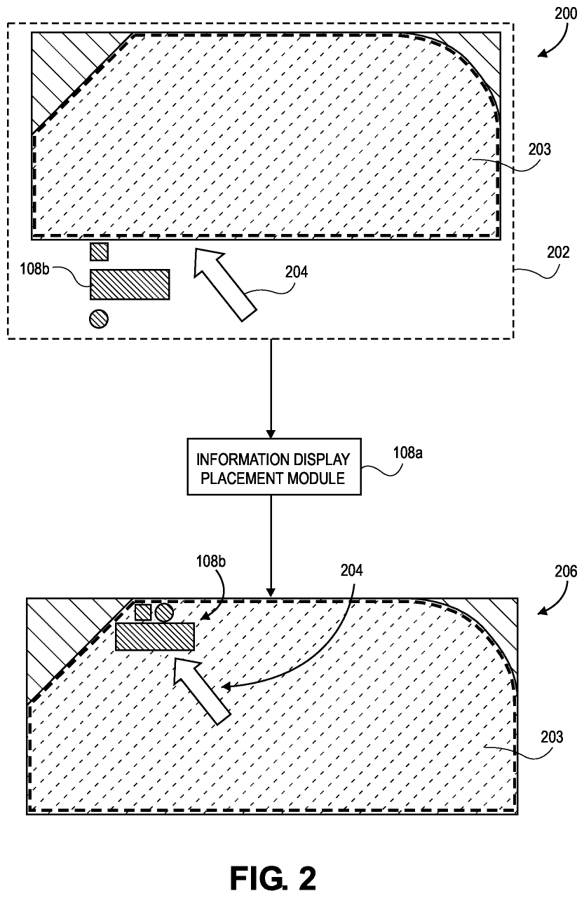

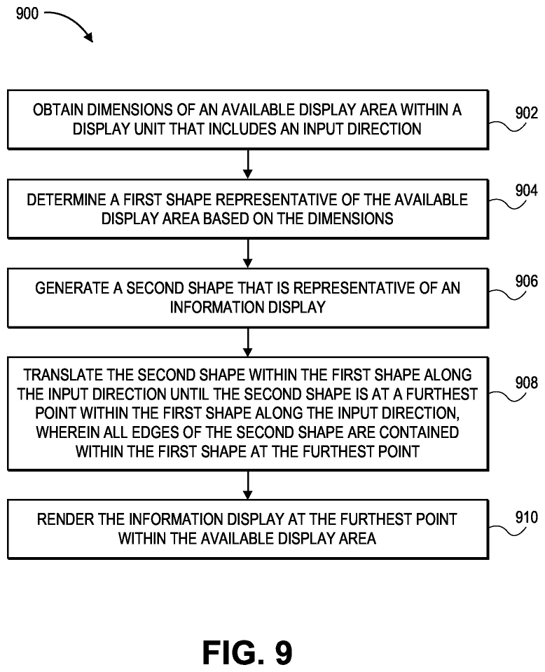

To provide a better understanding of the general description provided above, the present techniques are described herein with reference to FIGS. 1A-9. In particular, FIGS. 1A and 1B discuss exemplary systems and/or environments in which the techniques for optimizing information display placement within display units of the present disclosure may be implemented. Thereafter, exemplary techniques for optimal information display placement within display units are described in reference to FIGS. 2-8D. Finally, an exemplary method for optimizing information display placement within display units is provided in reference to FIG. 9.

It should be understood that the techniques of the present disclosure are described herein in reference to a vehicle display unit (e.g., a vehicle information cluster), and more specifically to a navigation application displayed on a vehicle display unit, for ease of discussion only. The present techniques may be applied to any suitable information display unit in any suitable context.

Moreover, as used herein, the term “irregular shape” may refer to a shape or combination of shapes having unequal angles or at least one curved edge. An irregular shape may be concave or convex, may be a polygon with straight edges, or may include curved edges, or a combination of curved and straight edges.

### Example Hardware and Software Components

Referring first to FIG. 1A, an example communication system 100 in which the techniques of this disclosure can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, etc. In some embodiments, the user computing device 102 may be removably mounted in a vehicle, embedded into a vehicle, and/or may be capable of interacting with a head unit of a vehicle to provide navigation instructions, as described in more detail with reference to FIG. 1B.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc.

Further, the navigation application 108 may include an information display placement module 108a configured to implement and/or support the techniques of this disclosure for optimizing placement of information displays within a display unit (e.g., cluster display unit 151). Namely, the display placement module 108a may determine shapes corresponding to the available display area of the display unit and an information display, translate the information display shape to a furthest point within the shape representative of the available display area, and render the information display at the furthest point within the available display area (e.g., as part of the display of the cluster display unit 151). The information display placement module 108a may also obtain/utilize dimensions of the available display area within the display unit, along with an input direction, in order to translate the information display shape to the furthest point within the shape representative of the available display area.

Thus, as part of this functionality, the navigation application 108 also includes one or more information displays 108b. Each of the one or more information displays 108b may represent a distinct information widget including information for display to a user. For example, each of the one or more information displays 108b may be or include a speed limit, a warning, an alert, a traffic indication, a navigation indication (e.g., turn arrow), and/or any other suitable indication or combinations thereof.

It is noted that although FIG. 1A illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and presenting outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1A or, conversely, additional components.

The user computing device 102 may communicate with a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content from a map database 155 to the vehicle computing device 150 for display on the cluster display unit 151. Additionally, or alternatively, the navigation application 108 may access map, navigation, and geo-located content that is stored locally at the user computing device 102, and may access the map database 155 periodically to update the local data or during navigation to access real-time information, such as real-time traffic data.

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The vehicle computing device 150 includes one or more processor(s) 152 and a memory 153 storing computer-readable instructions executable by the processor(s) 152. The memory 153 may store a navigation application 154 that is similar to the navigation application 108. The navigation application 154 may support similar functionalities as the navigation application 108 from the vehicle-side and may facilitate rendering of information displays, as described herein. For example, in certain aspects, the user computing device 102 may provide the vehicle computing device 150 with information displays along with furthest points corresponding to the cluster unit display 151 where the information displays should be rendered. The navigation application 154 may then proceed to render the information displays at the respective furthest points for each information display within the cluster unit display 151. Additionally, or alternatively, to facilitate these vehicle-side functions, the vehicle computing device 150 may include an information display placement module 154a and information displays 154b.

Generally, the user computing device 102 may communicate with the vehicle computing device 150 to obtain dimensions of the cluster display unit 151, and more particularly the available area of the cluster display unit 151 where an information display may be rendered. The vehicle computing device 150 may provide the dimensions to the user computing device 102 in any suitable manner, such as through an application programming interface (API) configured to communicate data between the vehicle computing device 150 and the user computing device 102. The vehicle computing device 150 may also provide an input direction to the user computing device 102 that specifies a two-dimensional (2D) direction in which the information display placement module 108a will place the information displays 108b within the cluster display unit 151. The information display placement module 108a may then utilize the dimensions and input direction provided by the vehicle computing device 150 to determine the furthest point within the available display area of the cluster display unit 151 where the information displays 108b may be placed and rendered for display to a user.

In any event, the user computing device 102 may be communicatively coupled to various databases, such as a map database 155, a traffic database 157, and a point-of-interest (POI) database 159, from which the user computing device 102 can retrieve navigation-related data. The map database 155 may include map data such as map tiles, visual maps, road geometry data, road type data, speed limit data, etc. The traffic database 157 may store historical traffic information as well as real-time traffic information. The POI database 159 may store descriptions, locations, images, and other information regarding landmarks or points-of-interest. While FIG. 1A depicts databases 155, 157, and 159, the user computing device 102 and/or the vehicle computing device 150 may be communicatively coupled to additional, or conversely, fewer, databases. For example, the user computing device 102 and/or the vehicle computing device 150 may be communicatively coupled to a database storing weather data.

Turning to FIG. 1B, the user computing device 102 may transmit information for rendering/display within a vehicle environment 170. The user computing device 102 may be located within a vehicle 172, and may be a smartphone. However, while FIG. 1B depicts the user computing device 102 as a smartphone, this is for ease of illustration only, and the user computing device 102 may be any suitable type of device and may include any suitable type of portable or non-portable computing devices.

In any event, the vehicle 172 may include a head unit 174, which in some aspects, may include and/or otherwise house the user computing device 102. Even if the head unit 174 does not include the user computing device 102, the device 102 may communicate (e.g., via a wireless or wired connection) with the head unit 174 to transmit navigation information, such as maps or audio instructions and/or information displays to the head unit 174 for the head unit 174 to display or emit. Additionally, the vehicle 172 includes the cluster display unit 151, which may display information displays transmitted from the user computing device 102. In certain aspects, a user may interact with the user computing device 102 by interacting with head unit controls. In addition, the vehicle 172 may provide the communication link 140, and the communication link 140, for example, may include a wired connection to the vehicle 172 (e.g., via a USB connection) through which the user computing device 102 may transmit the information displays and the corresponding furthest points for rendering within the cluster display unit 151.

Accordingly, the head unit 174 may include a display 176 for outputting navigation information such as a digital map. Of course, the cluster display unit 151 may also display such navigation information, including a digital map. Such a map rendered within the cluster display unit 151 may provide a driver of the vehicle 172 with more optimally located navigation instructions, and as a result, the driver may not be forced to look away from the active roadway as much while driving in order to safely navigate to their intended destination. Nevertheless, the display 176 in some implementations includes a software keyboard for entering text input, which may include the name or address of a destination, point of origin, etc. Hardware input controls 178 and 180 on the head unit 174 and the steering wheel, respectively, can be used for entering alphanumeric characters or to perform other functions for requesting navigation directions. For example, the hardware input controls 178, 180 may be and/or include rotary controls (e.g., a rotary knob), trackpads, touchscreens, and/or any other suitable input controls. The head unit 174 also can include audio input and output components such as a microphone 182 and speakers 184, for example. As an example, the user computing device 102 may communicatively connect to the head unit 174 (e.g., via Bluetooth™, WiFi, cellular communication protocol, wired connection, etc.) or may be included in the head unit 174. The user computing device 102 may present map information via the cluster display unit 151, emit audio instructions for navigation via the speakers 184, and receive inputs from a user via the head unit 174 (e.g., via a user interacting with the input controls 178 and 180, the display 176, or the microphone 182).

### Example Techniques Involving Placement of Information Displays

The techniques of this disclosure for optimizing placement of information displays are discussed below with reference to the exemplary techniques illustrated in FIGS. 2-8D. Throughout the description of FIGS. 2-8D, actions described as being performed by the user computing device 102 may, in some implementations, be performed by the vehicle computing device 150 or may be performed by the user computing device 102 and the vehicle computing device 150 in parallel. For example, either the user computing device 102 and/or the vehicle computing device 150 may utilize the information display placement module 108a, 154a to translate information displays to respective furthest points within the available display area of a display unit (e.g., cluster display unit 151).

Referring to FIG. 2, the user computing device 102 may implement the navigation application 108 and may perform the example placement 200 of the information displays 108a utilizing the information display placement module 108a of FIG. 1A, in accordance with embodiments herein. Generally speaking, the example placement 200 includes a preliminary setup 202 wherein the user computing device 102 obtains dimensions of an available display unit area 203 within a display unit (e.g., cluster display unit 151) and an input direction 204. The dimensions of the available display unit area 203, the input direction 204, and the information displays 108b may be utilized by the information display placement module 108a to generate the completed placement 206 that features each of the information displays 108b placed within the available display unit area 203 at a furthest point relative to the input direction 204. The dimensions of the available display unit area 203 may also correspond to a two-dimensional (2D) shape (e.g., the dashed line running along the interior border of the available display unit area 203 in FIG. 2) that represents the available display unit area 203, and that may be utilized by the information display placement module 108a, as described herein. Moreover, it should be understood that the information displays 108b illustrated in FIG. 2 are represented as shapes that the information display placement module 108a generates in order to place the information displays 108b within the available display unit area 203.

More specifically, the information display placement module 108a may produce an arrangement of the information displays 108b within the available display unit area 203 such that the displays 108b are optimally located within the available display unit area 203 relative to the input direction 204. In this context, an individual information display 108b may be “optimally” located within the available display unit area 203 when the individual information display 108b is entirely contained within the available display unit area 203 in a location that is furthest relative to the input direction 204. Further, an information display 108b may be “entirely contained” within the available display unit area 203 when all edges of the information display 108b are located internally to all edges of the available display unit area 203, and one or more edges of the information display 108b may contact one or more edges of the available display unit area 203. Of course, the dimensions of the available display unit area 203 and the input direction 204 may be arbitrary, and the information display placement module 108a may analyze multiple suitable locations within the available display unit area 203 to determine the furthest point relative to the input direction 204 that is within the available display unit area 203 where a particular information display 108b may be entirely contained within the available display unit area 203.

As an example, and as illustrated in FIG. 2, the information display placement module 108a may obtain the dimensions of the available display unit area 203 and the input direction 204, and may proceed to generate shapes corresponding to the information displays 108b that are to be placed within the available display unit area 203. The information display placement module 108a may evaluate each information display 108b individually to determine an optimal location for each display 108b, and/or the module 108a may evaluate the set of information displays 108b collectively to determine an optimal location for the set within the available display unit area 203. In any event, the information display placement module 108a may utilize dimensions of a generated shape representing an information display 108b and the input direction 204 to determine that the optimal location for the information display 108b is in the upper left-hand corner of the available display unit area 203. Similarly, the information display placement module 108a may determine that the optimal location for each of the information displays 108b is in the upper left-hand corner of the available display unit area 203. Thus, as illustrated in FIG. 2, the information display placement module 108a may place the information displays 108b in the upper left-hand corner of the available display unit area 203 without overlapping any of the information displays 108b.

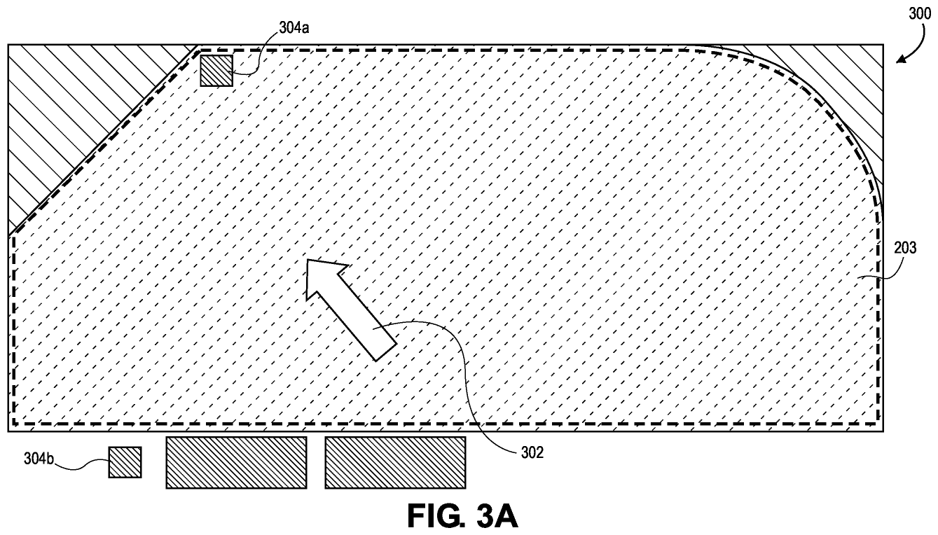

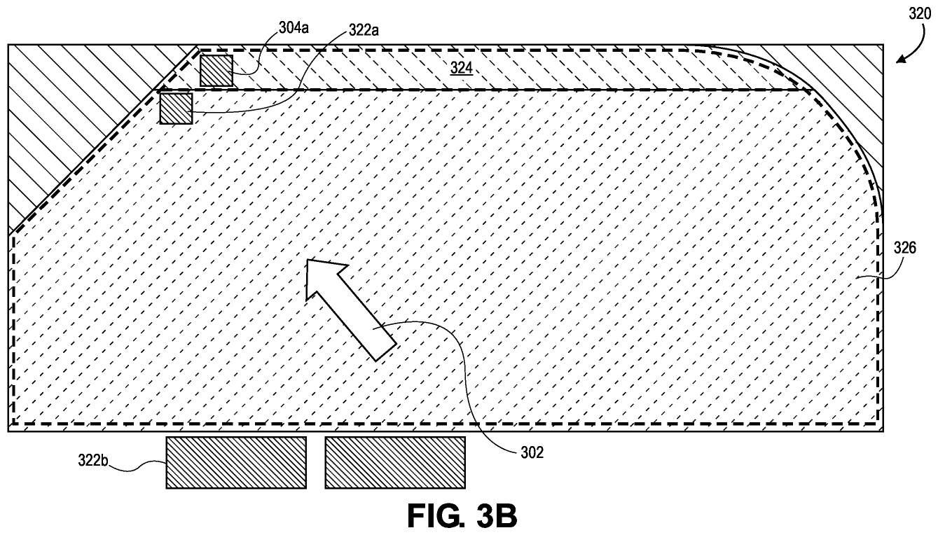

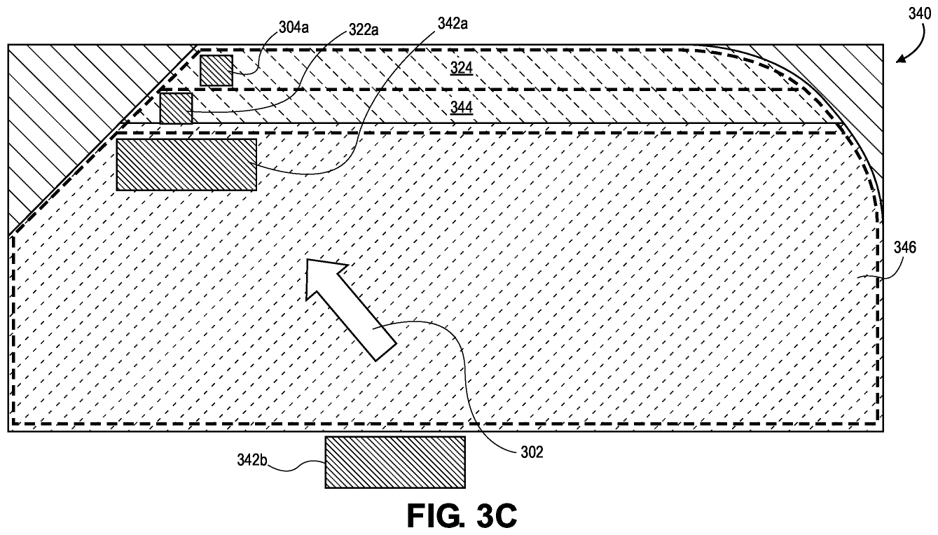

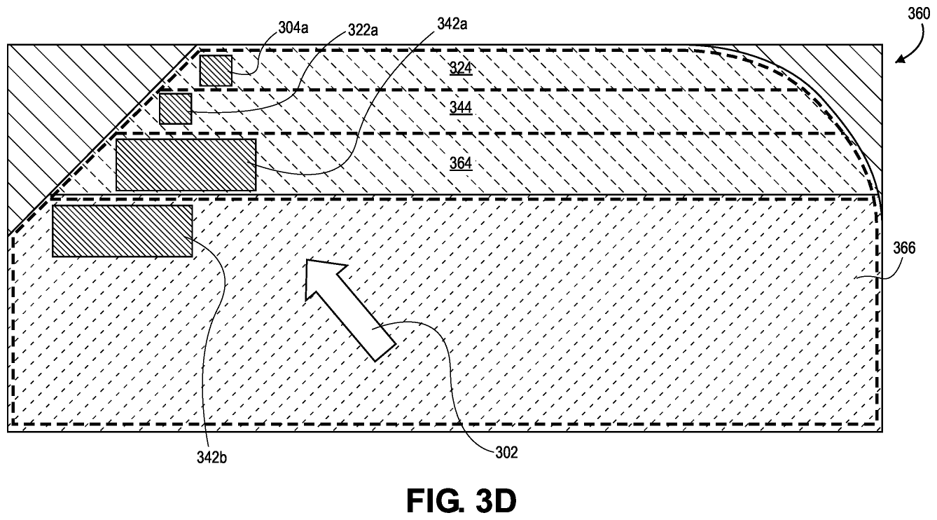

As indicated in the prior example, for a given input direction (e.g., input direction 204) two information displays having identical dimensions may not be placed in the same optimal location. In order for the information included in the individual information displays to be unobscured when rendered for viewing by a user, the information displays must be placed within the available display area without overlapping. One such solution to facilitate this requirement is illustrated in FIG. 2, wherein two of smaller, square information displays 108b are placed adjacent to one another near the upper left-hand corner of the available display unit area 203. Another solution to facilitate this requirement is shown in FIGS. 3A-D, where a set of information displays are sequentially placed within the available area of a display unit by eliminating a portion of the available area of the display unit after an information display is placed within the portion.

In reference to FIG. 3A, a first example information display placement 300 includes an input direction 302 and a first information display shape 304a to be placed within the available display unit area 203. As previously described, the information display placement module 108a may obtain the dimensions of the available display unit area 203 and the input direction 302, generate the first information display shape 304a to represent a first information display, and proceed to place the first information display shape 304a within the available display unit area 203 at the furthest point relative to the input direction 302 that is within the available display unit area 203. Each of the remaining information display shapes 304b have not yet been placed by the information display placement module 108a, and may be sequentially placed in accordance with a removal policy enforced by the module 108a. The removal policy may generally correspond to removing a portion of the available display area that corresponds to the location where the first information display shape 304a was placed.

For example, and as illustrated in FIG. 3B, a first removed portion 324 (indicated by the different patterning relative to the remaining available display area 326) of the available display unit area 203 of FIG. 3A may be designated by the information display placement module 108a as unavailable for placement of any of the remaining information display shapes 304b in FIG. 3A. In FIG. 3B, the first removed portion 324 is a horizontal strip that is approximately the height of the first information display shape 304a, and that extends across the top of the available display unit area 203 of FIG. 3A. Once the information display placement module 108a designates the first removed portion 324, the module 108a may proceed with placing the remaining information display shapes 304b in FIG. 3A without placing any of the shapes 304b within the first removed portion 324.

Of course, the first removed portion 324 illustrated in FIG. 3B is for the purposes of illustration only, and removed portions of the available display unit area 203 of FIG. 3A may be of any suitable shape (e.g., straight strip, tapering strip, circle, polygon, etc.), in any suitable orientation (e.g., horizontal, vertical, angled), and/or any suitable combinations thereof. In certain instances, and as previously mentioned in reference to FIG. 2, the first removed portion 324 may be identical dimensions to the first information display shape 304a, and may be designated to cover the identical location of the placement of the shape 304a such that only the area of the available display unit area 203 occupied by the shape 304a is removed from the available display unit area 203 when the information display placement module 108a proceeds to place the remaining information display shapes 304b of FIG. 3A.

Regardless, when the information display placement module 108a designates the first removed portion 324, the module 108a may proceed to place a second information display shape 322a. In particular, the information display placement module 108a may obtain and/or otherwise determine updated dimensions for the available display unit area 203 based on the first removed portion 324. The information display placement module 108a may eliminate the first removed portion 324 from the available display unit area 203, generate an updated shape representative of the remaining available display area 326 (e.g., the dashed line polygon under the first removed portion 324), and may proceed to place the second information display shape 322a within the remaining available display area 326.

When the remaining available display area 326 is determined, the information display placement module 108a may then translate the second information display shape 322a within the remaining available display area 326 until the module 108a determines the optimal location for the shape 322a relative to the input direction 302 that is within the area 326. Thereafter, the information display placement module 108a may place the second information display shape 322a at the optimal location (e.g., the upper left-hand corner of the remaining available display area 326), and proceed to designate a second removed portion corresponding to the location of the second information display shape 322a within the remaining available display area 326. Each of the remaining information display shapes 322b have not yet been placed by the information display placement module 108a, and may be sequentially placed in accordance with the removal policy enforced by the module 108a.

As illustrated in FIG. 3C, the information display placement module 108a may designate a second removed portion 344 (indicated by the similar patterning relative to the first removed portion 324) of the available display unit area 203 of FIG. 3A as unavailable for placement of any of the remaining information display shapes 322b in FIG. 3B. In FIG. 3C, the second removed portion 344 is a horizontal strip that is approximately the height of the second information display shape 322a, and that extends across the top of the remaining available display area 326 of FIG. 3B. Once the information display placement module 108a designates the second removed portion 344, the module 108a may proceed with placing the remaining information display shapes 322b in FIG. 3B without placing any of the shapes 322b within the first removed portion 324 or the second removed portion 344.

Of course, the second removed portion 344 illustrated in FIG. 3C is for the purposes of illustration only, and removed portions of the remaining available display area 326 of FIG. 3B may be of any suitable shape (e.g., straight strip, tapering strip, circle, polygon, etc.), in any suitable orientation (e.g., horizontal, vertical, angled), and/or any suitable combinations thereof. In certain instances, the second removed portion 344 may be identical dimensions to the second information display shape 322a, and may be designated to cover the identical location of the placement of the shape 322a such that only the area of the remaining available display area 326 occupied by the shape 322a is removed from the remaining available display area 326 when the information display placement module 108a proceeds to place the remaining information display shapes 322b of FIG. 3B.

Regardless, when the information display placement module 108a designates the second removed portion 344, the module 108a may proceed to place a third information display shape 342a. In particular, the information display placement module 108a may obtain and/or otherwise determine updated dimensions for the remaining available display area 326 based on the second removed portion 344. The information display placement module 108a may eliminate the second removed portion 344 from the remaining available display area 326, generate an updated shape representative of the remaining available display area 346 (e.g., the dashed line polygon under the second removed portion 344), and may proceed to place the third information display shape 342a within the remaining available display area 346.

When the remaining available display area 346 is determined, the information display placement module 108a may then translate the third information display shape 342a within the remaining available display area 346 until the module 108a determines the optimal location for the shape 342a relative to the input direction 302 that is within the area 346. Thereafter, the information display placement module 108a may place the third information display shape 342a at the optimal location (e.g., the upper left-hand corner of the remaining available display area 346), and proceed to designate a third removed portion corresponding to the location of the third information display shape 342a within the remaining available display area 346. The remaining information display shape 342b has not yet been placed by the information display placement module 108a, and may be placed in accordance with the removal policy enforced by the module 108a.

In particular, and as illustrated in FIG. 3D, the information display placement module 108a may designate a third removed portion 364 (indicated by the similar patterning relative to the first/second removed portions 324, 344) of the available display unit area 203 of FIG. 3A as unavailable for placement of any of the remaining information display shapes 342b in FIG. 3C. In FIG. 3D, the third removed portion 364 is a horizontal strip that is approximately the height of the third information display shape 342a, and that extends across the top of the remaining available display area 346 of FIG. 3C. Once the information display placement module 108a designates the third removed portion 364, the module 108a may proceed with placing the remaining information display shape 342b in FIG. 3C without placing the shape 342b within the first removed portion 324, the second removed portion 344, or the third removed portion 364.

Of course, the third removed portion 364 illustrated in FIG. 3D is for the purposes of illustration only, and removed portions of the remaining available display area 346 of FIG. 3C may be of any suitable shape (e.g., straight strip, tapering strip, circle, polygon, etc.), in any suitable orientation (e.g., horizontal, vertical, angled), and/or any suitable combinations thereof. In certain instances, the third removed portion 364 may be identical dimensions to the third information display shape 342a, and may be designated to cover the identical location of the placement of the shape 342a such that only the area of the remaining available display area 346 occupied by the shape 342a is removed from the remaining available display area 346 when the information display placement module 108a proceeds to place the remaining information display shape 342b. Moreover, the four information display shapes 304a, 322a, 342a, 342b are for the purposes of illustration only, and the information display placement module 108a may iteratively place any suitable number of information display shapes in any suitable portions of the available display area (e.g., available display area 203).

Regardless, when the information display placement module 108a designates the third removed portion 364, the module 108a may proceed to place the remaining information display shape 342b. In particular, the information display placement module 108a may obtain and/or otherwise determine updated dimensions for the remaining available display area 346 based on the third removed portion 364. The information display placement module 108a may eliminate the third removed portion 364 from the remaining available display area 346, generate an updated shape representative of the remaining available display area 366 (e.g., the dashed line polygon under the third removed portion 364), and may proceed to place the remaining information display shape 342b within the remaining available display area 366.

When the remaining available display area 366 is determined, the information display placement module 108a may then translate the remaining information display shape 342b within the remaining available display area 366 until the module 108a determines the optimal location for the shape 342b relative to the input direction 302 that is within the area 366. Thereafter, the information display placement module 108a may place the remaining information display shape 342b at the optimal location (e.g., the upper left-hand corner of the remaining available display area 366), and proceed to transmit the finalized placement locations for each of the information display shapes 304a, 322a, 342a, 342b to the vehicle (e.g., vehicle computing device 150) for rendering on the display unit (e.g., cluster display unit 151).

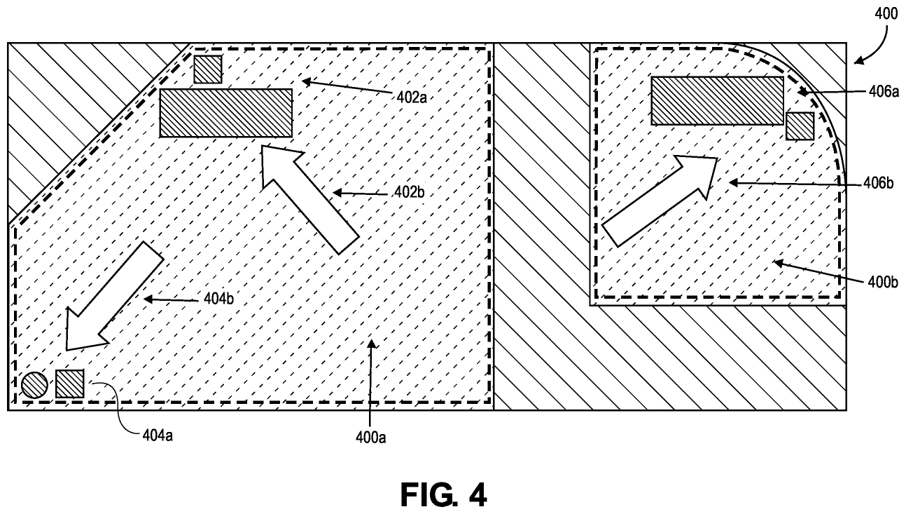

However, the available display area may not always comprise a single, connected shape, and different information displays may include and/or otherwise be associated with different input directions. For example, FIG. 4 illustrates an example placement 400 of a set of information displays within a divided display unit area of a display unit utilizing multiple input directions, in accordance with embodiments herein. The example placement 400 generally includes a first available display unit area 400a and a second available display unit area 400b where information displays may be placed for rendering and display to a user. In this example placement 400, the information display placement module 108a may obtain dimensions corresponding to both available display unit areas 400a, 400b, and may generate shapes corresponding to both areas 400a. 400b (represented by the dashed lines interior to both areas 400a, 400b).

When the dimensions of both available display unit areas 400a, 400b are obtained, and the corresponding shapes generated, the information display placement module 108a may also obtain multiple sets of information displays and corresponding input directions in order to place the information displays within the areas 400a, 400b. Of course, it should be appreciated that the information display placement module 108a may obtain the dimensions for the available display unit areas 400a, 400b before, during, and/or after obtaining the sets of information displays and corresponding input directions.

In any event, the information display placement module 108a may then generate a first set of information display shapes 402a based on the first set of information displays, and may place each individual information display shape of the first set of information display shapes 402a within the available display unit areas 400a, 400b one at a time, and/or the module 108a may place the first set of information display shapes 402a as a collective. Regardless, the information display placement module 108a may analyze the dimensions of the first set of information display shapes 402a along with the dimensions of the available display unit areas 400a, 400b to determine optimal locations for the first set of information display shapes 402a based on the first input direction 402b.

As part of this determination, the information display placement module 108a may analyze potential placement locations within the first available display unit area 400a and the second available display unit area 400b. For example, as illustrated in FIG. 4, the information display placement module 108a may analyze available placement locations for the first set of information display shapes 402a within the first available display unit area 400a relative to the first input direction 402b, and may determine that the optimal location within the area 400a is in the upper left-hand corner. The module 108a may also analyze available placement locations for the first set of information display shapes 402a within the second available display unit area 400b relative to the first input direction 402b, and may determine that the optimal location within the area 400b is also in the upper left-hand corner.

In this manner, the information display placement module 108a may evaluate all potential placement locations within the aggregate available display unit area (e.g., the combination of 400a, 400b) in order to determine the optimal location for the first set of information display shapes 402a between/amongst all of the available display unit area. Accordingly, the information display placement module 108a may determine that the optimal location within the first available display unit area 400a is further relative to the first input direction 402b than the optimal location within the second available display unit area 400b. As a result, the information display placement module 108a may place the first set of information display shapes 402a at the optimal location within the first available display unit area 400a because the optimal location in the area 400a represents the furthest location relative to the first input direction 402b that exists in either of the available display unit areas 400a, 400b.

Similarly, the information display placement module 108a may obtain a second set of information displays and a second input direction 404b, generate a second set of information display shapes 404a representative of the second set of information displays, and may proceed to place the shapes 404a at a furthest point relative to the second input direction 404b that is within the available display unit areas 400a, 400b. As illustrated in FIG. 4, the information display placement module 108a may analyze available placement locations for the second set of information display shapes 404a relative to the second input direction 404b that are within the first available display unit area 400a, and may determine that the optimal location within the area 400a is in the lower left-hand corner. The module 108a may also analyze available placement locations for the second set of information display shapes 404a relative to the second input direction 404b that are within the second available display unit area 400b, and may determine that the optimal location within the area 400b is also in the lower left-hand corner.

In this manner, the information display placement module 108a may evaluate all potential placement locations within the aggregate available display unit area (e.g., the combination of 400a, 400b) in order to determine the optimal location for the second set of information display shapes 404a between/amongst all of the available display unit area. Accordingly, the information display placement module 108a may determine that the optimal location relative to the second input direction 404b that is within the first available display unit area 400a is further along the second input direction 404b than the optimal location relative to the second input direction 404b that is within the second available display unit area 400b. As a result, the information display placement module 108a may place the second set of information display shapes 404a at the optimal location within the first available display unit area 400a because the optimal location in the area 400a represents the furthest location along the second input direction 404b that exists in either of the available display unit areas 400a, 400b.

As yet another example, the information display placement module 108a may obtain a third set of information displays and a third input direction 406b, generate a third set of information display shapes 406a representative of the third set of information displays, and may proceed to place the shapes 406a within the available display unit areas 400a, 400b along the third input direction 406b. As illustrated in FIG. 4, the information display placement module 108a may analyze available placement locations for the third set of information display shapes 406a within the first available display unit area 400a along the third input direction 406b, and may determine that the optimal location within the area 400a is in the upper right-hand corner. The module 108a may also analyze available placement locations for the third set of information display shapes 406a within the second available display unit area 400b along the third input direction 406b, and may determine that the optimal location within the area 400b is also in the upper right-hand corner.

In this manner, the information display placement module 108a may evaluate all potential placement locations within the aggregate available display unit area (e.g., the combination of 400a, 400b) in order to determine the optimal location for the third set of information display shapes 406a between/amongst all of the available display unit area. Accordingly, the information display placement module 108a may determine that the optimal location within the second available display unit area 400b is further along the third input direction 406b than the optimal location within the first available display unit area 400a. As a result, the information display placement module 108a may place the third set of information display shapes 406a at the optimal location within the second available display unit area 400b because the optimal location in the area 400b represents the furthest location along the third input direction 406b that exists in either of the available display unit areas 400a, 400b.

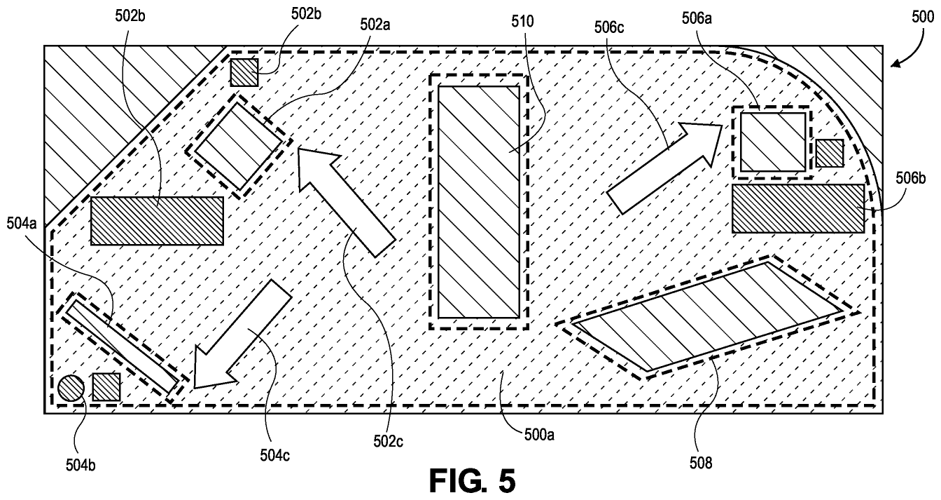

Additionally, in certain instances, the available display area may include cut-outs or holes, such that the available display area is non-uniform. For example, FIG. 5 illustrates an example placement 500 of a set of information displays within a display unit area of a display unit featuring several holes utilizing multiple input directions. The example placement 500 generally includes an available display unit area 500a that includes multiple interior holes (e.g., holes 502a, 504a, 506a, 508, and 510) where information displays may not be placed. In this example placement 500, the information display placement module 108a may obtain dimensions corresponding to the available display unit area 500a, and may generate a shape corresponding to the area 500a (represented by the dashed lines interior to the perimeter of the area 500a). The information display placement module 108a may also obtain dimensions corresponding to each of the holes 502a, 504a, 506a, 508, 510, and may generate corresponding shapes (represented by the dashed lines exterior to the perimeter of each hole).

When the dimensions of the available display unit area 500a and the holes 502a, 504a, 506a, 508, 510 are obtained, and the corresponding shapes generated, the information display placement module 108a may obtain multiple sets of information displays and the corresponding input directions. Of course, it should be appreciated that the information display placement module 108a may obtain the dimensions for the available display unit area 500a (and any holes) before, during, and/or after obtaining the sets of information displays and corresponding input directions.

For example, the information display placement module 108a may generate a first set of information display shapes 502b based on a first set of information displays, and may place each individual information display shape of the first set of information display shapes 502b within the available display unit area 500a one at a time, and/or the module 108a may place the first set of information display shapes 502b as a collective. Regardless, the information display placement module 108a may analyze the dimensions of the first set of information display shapes 502b along with the dimensions of the available display unit area 500a and the holes 502a, 504a, 506a, 508, 510 to determine optimal locations for the first set of information display shapes 502b based on the first input direction 502c.

Namely, as illustrated in FIG. 5, the information display placement module 108a may analyze available placement locations for the first set of information display shapes 502b relative to the first input direction 502c that are within the available display unit area 500a, and may determine that the optimal location within the area 500a is in the upper left-hand corner. However, the information display placement module 108a may determine that the first hole 502a prevents each information display shape of the first set of information display shapes 502b from being placed in the upper left-hand corner. Instead, the information display placement module 108a may determine that the optimal location for the first set of information display shapes 502b is to surround the first hole 502a in the upper left-hand corner of the available display unit area 500a.

As another example, the information display placement module 108a may generate a second set of information display shapes 504b based on a second set of information displays, and may place each individual information display shape of the second set of information display shapes 504b within the available display unit area 500a one at a time, and/or the module 108a may place the second set of information display shapes 504b as a collective. Regardless, the information display placement module 108a may analyze the dimensions of the second set of information display shapes 504b along with the dimensions of the available display unit area 500a and the holes 502a, 504a, 506a, 508, 510 to determine optimal locations for the second set of information display shapes 504b based on the second input direction 504c.

Namely, as illustrated in FIG. 5, the information display placement module 108a may analyze available placement locations for the second set of information display shapes 504b relative to the second input direction 504c that are within the available display unit area 500a, and may determine that the optimal location within the area 500a is in the lower left-hand corner. Further, the information display placement module 108a may determine that the second hole 504a does not prevent each information display shape of the second set of information display shapes 504b from being placed in the lower left-hand corner. Accordingly, the information display placement module 108a may determine that the optimal location for the second set of information display shapes 504b is between the second hole 504a and the lower left-hand corner of the available display unit area 500a.

As yet another example, the information display placement module 108a may generate a third set of information display shapes 506b based on a third set of information displays, and may place each individual information display shape of the third set of information display shapes 506b within the available display unit area 500a one at a time, and/or the module 108a may place the third set of information display shapes 506b as a collective. Regardless, the information display placement module 108a may analyze the dimensions of the third set of information display shapes 506b along with the dimensions of the available display unit area 500a and the holes 502a, 504a, 506a, 508, 510 to determine optimal locations for the third set of information display shapes 506b based on the third input direction 506c.

Namely, as illustrated in FIG. 5, the information display placement module 108a may analyze available placement locations for the third set of information display shapes 506b within the available display unit area 500a along the third input direction 506c, and may determine that the optimal location within the area 500a is in the upper right-hand corner. Further, the information display placement module 108a may determine that the third hole 506a prevents each information display shape of the third set of information display shapes 506b from being placed in the upper right-hand corner. Accordingly, the information display placement module 108a may determine that the optimal location for the third set of information display shapes 506b is adjacent to and/or below the third hole 506a.

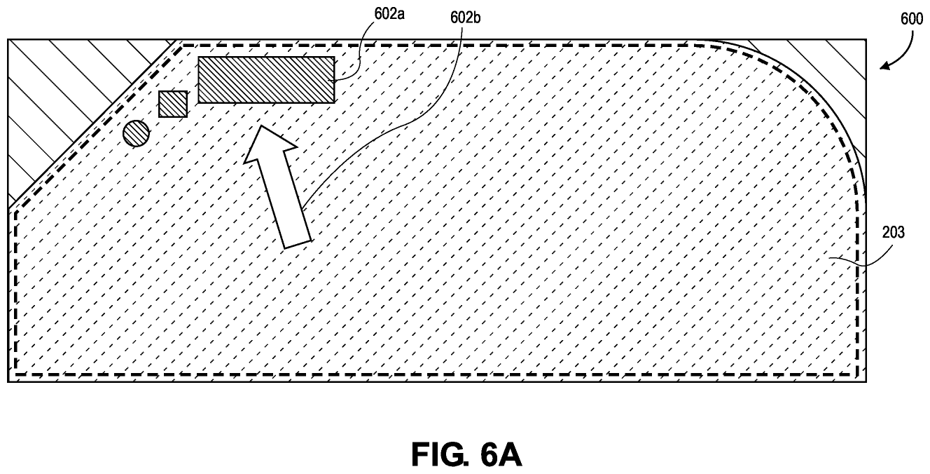

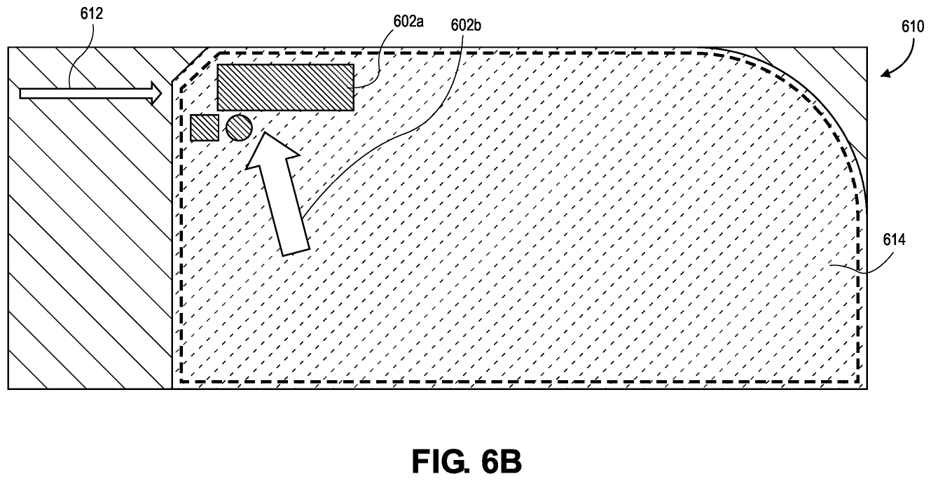

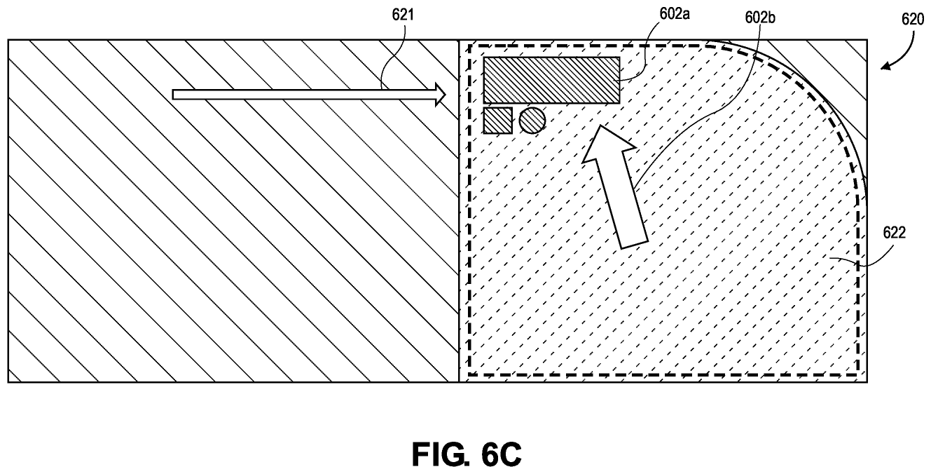

Moreover, in certain devices and/or for certain applications, the available display area may dynamically change as the displayed content occupies more or less of the display area. For example, FIGS. 6A-C illustrate an example placement sequence of a set of information displays within a dynamically adjusting display unit area of a display unit, in accordance with embodiments herein. Generally speaking, as the available display unit area increases/decreases, the information display placement module 108a may automatically determine new optimal locations to place each information display that is included as part of the overall display. It should be understood that if the available display unit area decreases, the information display placement module 108a may be required to remove certain information displays from the available display unit area. Conversely, if the available display unit area increases, the information display placement module 108a may include additional information displays into the available display unit area.

In any event, FIG. 6A illustrates a first example placement 600 performed by the information display placement module 108a that includes a set of information display shapes 602a placed at an optimal location relative to the input direction 602b that is within the available display unit area 203. The information display placement module 108a may determine this optimal placement for the set of information display shapes 602a at a first time when the entirety of the available display unit area 203 is available to display the shapes 602a, based on the dimensions and corresponding generated shape representing the available display unit area 203. However, at a second time, the available display unit area 203 may decrease in size when, for example, a new application is rendered for display within a portion of the available display unit area 203.

To provide a better understanding of the adjustments to the available display unit area 203, and by extension the placement of the set of information display shapes 602a, FIG. 6B illustrates a second example placement 610 that takes place while the available display unit area 203 shrinks (illustrated by the distance 612) to become the available display unit area 614. As illustrated in FIG. 6B, the available display area 614 is smaller than the prior available display unit area 203, and as a result, the set of information display shapes 602a are not able to be displayed in the same location as illustrated in FIG. 6A. Instead, the information display placement module 108a obtains updated dimensions of the available display unit area 614, generates an updated shape representing the area 614 (indicated by the dashed lines along the interior perimeter of the area 614), and determines the optimal locations relative to the input direction 602b for each information display shape of the set of information display shapes 602a. As a result, the optimal locations for the set of information display shapes 602a may remain in the upper left-hand corner of the available display unit area 614, but the optimal locations may be shifted slightly to the right of the corresponding optimal locations for each information display shape within the available display unit area 203 due to the changing shape (e.g., size reduction of slanted line of available display unit 203) of the available display unit area 203 as a result of the movement of the left-most edge by the distance 612 that shrinks the available display unit area 203.

In certain instances, the shrinking of the available display unit area may continue, such that the information display placement module 108a may determine additional optimal locations for the information displays until the available display unit area stops adjusting. It should be understood that the information display placement module 108a may adjust the optimal locations for each individual information display any suitable number of times and/or at any suitable frequency based on the size adjustments of the available display unit area. For example, if the available display unit area progressively shrinks in size to accommodate a new application for display (e.g., a modified display of a speedometer), the information display placement module 108a may determine new optimal locations for each individual information display within the available display unit area every few milliseconds, for every square centimeter of available display unit area that is eliminated, and/or at any suitable frequency determined by any suitable metric.

In any event, the available display unit area may continue to adjust, and FIG. 6C illustrates a third example placement 620 based on such a continued adjustment. In the third example placement 620, the available display unit area 614 shrinks (illustrated by the distance 621) to become the available display unit area 622. As illustrated in FIG. 6C, the available display area 622 is smaller than the prior available display unit area 614, and as a result, the set of information display shapes 602a are not able to be displayed in the same location as illustrated in FIG. 6B. Instead, the information display placement module 108a obtains updated dimensions of the available display unit area 622, generates an updated shape representing the area 622 (indicated by the dashed lines along the interior perimeter of the area 622), and determines the optimal locations relative to the input direction 602b for each information display shape of the set of information display shapes 602a. As a result, the optimal locations for the set of information display shapes 602a may remain in the upper left-hand corner of the available display unit area 622, but the optimal locations may be shifted slightly to the right of the corresponding optimal locations for each information display shape within the available display unit area 614 due to the shrinking of the available display unit area 614 from the movement of the left-most edge by the distance 621.

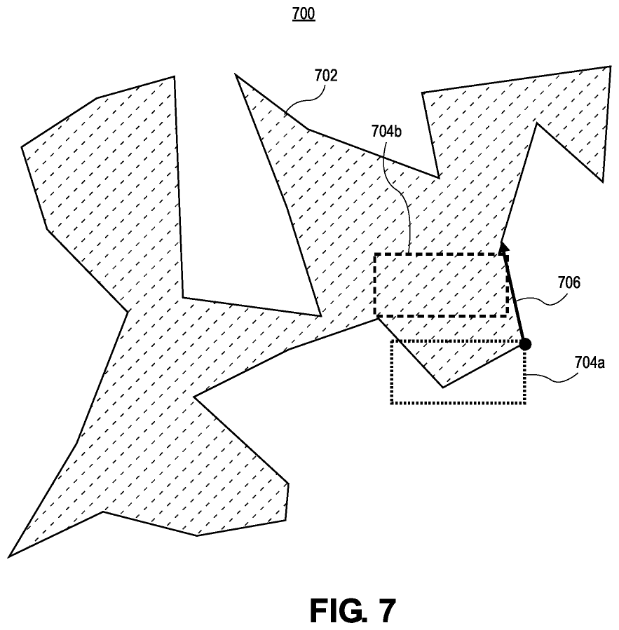

To provide a better understanding of the particular methodology utilized by the information display placement module 108a, FIG. 7 illustrates an example translation sequence 700 of an information display along an edge of an available display area of a display unit to determine feasible placement regions for the information display within the available display area, in accordance with embodiments herein. The example translation sequence 700 includes an irregular available display unit area 702, an initial translation position 704a for an information display shape, a feasible translation position 704b for the information display shape, and a translation direction 706. Generally speaking, the example translation sequence 700 involves the information display placement module 108a translating the information display shape from the initial translation position 704a along the entire length of the edge of the irregular available display unit area 702 covered by the translation direction 706. As a result of the translation, the information display placement module 108a may translate the information display from the initial translation position 704a, through the feasible translation position 704b, and to the end of the edge (e.g., at a vertex) of the irregular display unit area 702 covered by the translation direction 706.

More generally, the actions performed by the information display placement module 108a as part of the example translation sequence 700 may be characterized as follows: given a first shape (e.g., a 2D polygon) that is a proxy for the available display unit area, a second shape (e.g., an axis-parallel rectangle) that models the information display, and an input direction (e.g., a 2D vector), translate the second shape along the edges and vertices of the first shape such that the second shape is within the first shape while being furthest in the input direction.

As previously described in reference to FIGS. 2-6C, there may be many different circumstances in which the information display placement module 108a may be tasked with performing these actions, resulting in an even wider variety of possible solutions. However, the information display placement module 108a may also be configured to generate these possible solutions utilizing any number of different computational models. Each computational configuration for the information display placement module 108a may be chosen, for example, based on the capabilities of the user device (e.g., user computing device 102) and/or available processing/memory resources at the potential expense of longer/shorter running times. In each instance, the computational models may comprise three distinct stages including: (1) the module 108a analyzing the shape representative of the information display relative to all edges of the shape representative of the available display unit area; (2) the module 108a analyzing the shape representative of the information display relative to all vertices of the shape representative of the available display unit area; and (3) the module 108a evaluating an objective function for each of the aggregate set of feasible solutions associated with the edges and vertices of the shape representative of the available display unit area to determine the feasible solution with the highest objective function value.

As an example, the information display placement module 108a may execute an algorithm configured to run in time nearly linear relative to the complexity of the shape representing the available display unit area, and may use a nearly linear memory footprint. Utilizing a more robust computation model, the information display placement module 108a may execute basic arithmetic operations over the set of rational numbers along a lengthier timescale.

For example, the algorithm executed by the information display placement module 108a that executes on a nearly linear time scheme may require the construction of a segment Voronoi diagram of the edges of the shape representing the available display unit area. The construction of this diagram may require the information display placement module 108a to be able to represent an exact geometric structure. In contrast, the near quadratic time algorithm only requires the information display placement module 108a to represent an approximate ordered sequence of line segment intersections of the shape representing the available display unit area.

In any event, the computational algorithms executed by the information display placement module 108a may include several assumptions in order to simplify the resulting calculations. Namely, and for the sake of simplicity and without loss of generality, the shape representative of the available display unit area may be expressed as a sequence of n≥3 vertices on the z=0 plane, and may be simple. Further, the shape representative of the available display unit area may have edges that are pairwise non-intersecting, each edge of the shape may have a length more than 0 units, and the degree (number of adjacent edges) of each vertex may be exactly 2. Each vertex of the shape may be a point which expresses the geometry in the planar embedding, the vertices may also be handles to the points, and the points corresponding to the vertices may be arranged in a counterclockwise order (or any suitable order). Thus, traveling along any edge of the shape representative of the available display unit area, the interior of the shape may be to the left. Furthermore, edges of the shape representative of the available display unit area between consecutive vertices may be implied by a convex combination of the two bounding points corresponding to the vertices, and there may be an edge between the last and the first vertex.

Using this paradigm for the shape representative of the available display unit area, the shape representative of an information display may be expressed by any suitable number and type of parameters. For example, in aspects where the shape representative of an information display is a rectangle, the shape may be expressed as a combination of two parameters, l, w>0, where I is the length of the rectangle, and w is the width of the rectangle. This representation enables the information display placement module 108a to generate the family of rectangles of the form: ((0, 0), (l, 0), (l, w), (0, w)).

As another example, the more robust computational model implemented by the information display placement module 108a may operate over the set of rational numbers. This model may enable exact queries and constructions of the basic geometric objects included in the construction of the shapes representative of the available display unit area and the information display (e.g., points, intersections of line segments, point-polygon containment queries, line-segment containment in polygon queries, etc.). Such queries may avoid inconsistencies due to round-off/numerical errors, but as a result, these basic arithmetic operations are not (necessarily) constant time operations. Nevertheless, as executed by the information display placement module 108a, the basic arithmetic operations may be constant time operations based on the domain from which the input is drawn.

With all of these assumptions, the information display placement module 108a may begin the example translation sequence 700 by placing the shape representative of the information display at the initial translation position 704a. For ease of discussion only, the shape representative of the information display will be referenced in the context of the example translation sequence 700 as a rectangle, and the shape representative of the irregular available display unit area 702 will be referenced in the context of the example translation sequence 700 as a 2D polygon. The initial translation position 704a may be located at any arbitrary edge within the 2D polygon such that three of the vertices of the rectangle are in the half plane on the same side as the interior of the 2D polygon, and one vertex is on the interior of the arbitrary edge. The information display placement module 108a may then translate the rectangle along the edge, and the module 108a may track sub-intervals along the edge of the 2D polygon that are feasible/infeasible to associate them with the edge. The information display placement module 108a may also associate which vertex of the rectangle is placed on the edge.

Generally, positions along an edge may be feasible or infeasible based on whether or not the information display placement module 108a determines if the rectangle is entirely contained within the 2D polygon at the position. For example, the initial translation position 704a may represent an infeasible placement for the rectangle, and the feasible translation position 704b may represent a feasible placement for the rectangle within the 2D polygon. As such, for each edge of the 2D polygon, the information display placement module 108a may track the set of placements along the edges of the 2D polygon that are feasible in order to compile an aggregate set of feasible placements within the 2D polygon for the rectangle. In certain instances, in order to track the feasible placements along any given edge of the 2D polygon, the information display placement module 108a may determine the set of infeasible placements, and may thereafter determine the complement of that set. The complement of the set of infeasible placements must necessarily be the set of feasible placements, so the information display placement module 108a may determine the set of feasible placements directly or indirectly through calculating the complement of the set of infeasible placements.

Of course, even after executing the translation sequence 700 along every edge of the 2D polygon, the aggregate set of feasible placements within the 2D polygon may not include all feasible placements for the rectangle within the 2D polygon because the vertices of the 2D polygon are not considered during the translation sequence 700.

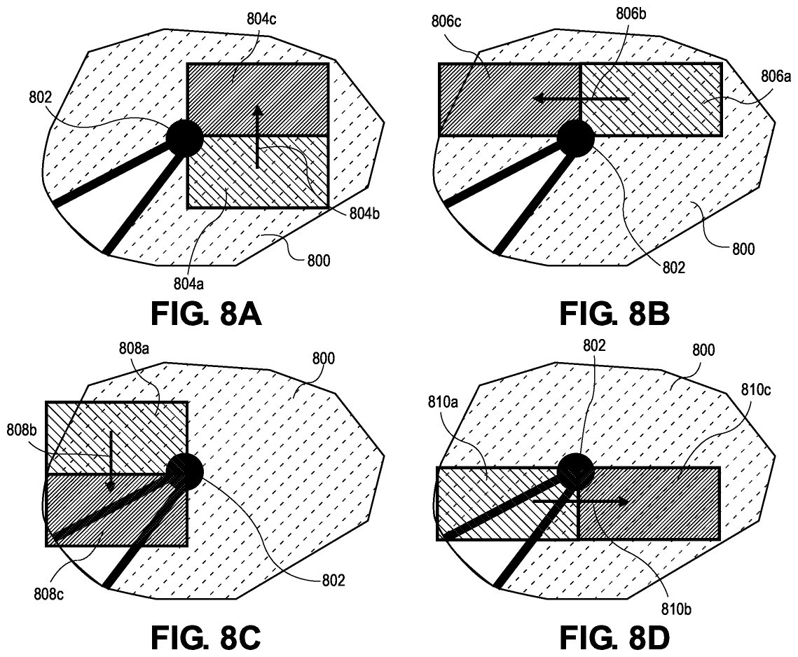

Thus, the information display placement module 108a must also analyze placements of the rectangle anchored at vertices of the 2D polygon. Accordingly, FIGS. 8A-D illustrate an example translation sequence of an information display along a vertex of an available display area of a display unit to determine feasible placement regions for the information display within the available display area, in accordance with embodiments herein. Generally, as part of the example translation sequence illustrated by FIGS. 8A-D, the information display placement module 108a may designate all edges of the shape representative of the information display that can be incident on the vertex 802. Subsequently, the information display placement module 108a may translate the shape representative of the information display along each designated edge, while maintaining contact between the designated edge and the vertex 802. For ease of discussion only, the shape representative of the information display will be referenced in the context of FIGS. 8A-D as a rectangle, and the shape representative of the available display unit area 800 will be referenced in the context of FIGS. 8A-D as a 2D polygon.

For example, as illustrated in FIG. 8A, the information display placement module 108a may place a rectangle within the available display unit area 800 at an initial translation location 804a where a first vertex of the rectangle contacts the vertex 802. The module 108a may then translate (illustrated by 804b) the rectangle along one of the two edges that are connected to the first vertex while keeping the edge in contact with the vertex 802 during the translation 804b, until the module 108a translates the rectangle to the ending translation location 804c. During the translation 804b, the information display placement module 108a may interpolate a series of rectangles between the initial translation location 804a and the ending translation location 804b in order to determine any suitable number of potential feasible placements for the rectangle.

Further, as illustrated in FIG. 8B, the information display placement module 108a may place the rectangle within the available display unit area 800 at an initial translation location 806a where a second vertex of the rectangle contacts the vertex 802. The module 108a may then translate (illustrated by 806b) the rectangle along one of the two edges that are connected to the second vertex while keeping the edge in contact with the vertex 802 during the translation 806b, until the module 108a translates the rectangle to the ending translation location 806c. During the translation 806b, the information display placement module 108a may interpolate a series of rectangles between the initial translation location 806a and the ending translation location 806b in order to determine any suitable number of potential feasible placements for the rectangle.

As illustrated in FIG. 8C, the information display placement module 108a may place a rectangle within the available display unit area 800 at an initial translation location 808a where a third vertex of the rectangle contacts the vertex 802. The module 108a may then translate (illustrated by 808b) the rectangle along one of the two edges that are connected to the third vertex while keeping the edge in contact with the vertex 802 during the translation 808b, until the module 108a translates the rectangle to the ending translation location 808c. During the translation 808b, the information display placement module 108a may interpolate a series of rectangles between the initial translation location 808a and the ending translation location 808b in order to determine any suitable number of potential feasible placements for the rectangle.

Moreover, as illustrated in FIG. 8D, the information display placement module 108a may place a rectangle within the available display unit area 800 at an initial translation location 810a where a fourth vertex of the rectangle contacts the vertex 802. The module 108a may then translate (illustrated by 810b) the rectangle along one of the two edges that are connected to the first vertex while keeping the edge in contact with the vertex 802 during the translation 810b, until the module 108a translates the rectangle to the ending translation location 810c. During the translation 810b, the information display placement module 108a may interpolate a series of rectangles between the initial translation location 810a and the ending translation location 810b in order to determine any suitable number of potential feasible placements for the rectangle.

Thus, after the information display placement module 108a completes the translation sequences illustrated in FIGS. 7-8D, the module 108a may generate a complete aggregate set of feasible placements for the rectangle within the 2D polygon. In order to determine the optimal placement of the rectangle, the information display placement module 108a may evaluate an objective function for each position included in the aggregate set of feasible placements. Broadly, if the aggregate set of feasible placements is non-empty, then it must contain an optimal solution. Accordingly, the information display placement module 108a may determine a feasible placement with a highest objective function value from the aggregate set of feasible placements. In particular, the objective function may be given by the following:

$$arg {max}_{f ∈ F} f \cdot {g}^{T} , \qquad ( 1 )$$

where f is a placement in the aggregate set of feasible placements, F is the aggregate set of feasible placements, and g is a vector corresponding to the input direction (e.g., a 2D input vector). When the information display placement module 108a evaluates equation (1) for each feasible placement in the aggregate set of feasible placements, the module 108a may determine a feasible placement with the highest corresponding objective function value, and may designate that feasible placement as the optimal placement for the information display.
Example Logic for Optimizing Information Display Placement within Display Units

FIG. 9 is a flow diagram illustrating an example method 900 for optimizing information display placement within display units, in accordance with the techniques of this disclosure. It is to be understood that, for ease of discussion only, the “user computing device” discussed herein in reference to FIG. 9 may correspond to the user computing device 102. The method 900 can be implemented by a user computing device (e.g., the user computing device 102), and more specifically, may be implemented in a set of instructions stored on a computer-readable memory and executable at one or more processors of the user computing device (e.g., the processor(s) 104).

Turning to FIG. 9, at block 902, the one or more processors of a user computing device may obtain dimensions of an available display area within a display unit that includes an input direction. In certain aspects, the one or more processors may obtain a two-dimensional (2D) input vector that includes the input direction. At block 904, the one or more processors may determine a first shape representative of the available display area based on the dimensions, and at block 906, the one or more processors may generate a second shape that is representative of an information display.

At block 908, the one or more processors may translate the second shape within the first shape until the second shape is at a furthest point relative to the input direction that is within the first shape. At the furthest point, all edges of the second shape may be contained within the first shape. In certain aspects, translating the second shape within the first shape until the second shape is at the furthest point further comprises determining a set of placements for the second shape within the first shape. In these aspects, all edges of the second shape are contained within the first shape at each placement of the set of placements. Moreover, the one or more processors may calculate a respective value of an objective function for each placement of the set of placements, and may determine the furthest point from the set of placements based on a respective placement of the set of placements that corresponds to a maximum respective value of the objective function relative to the respective value of the objective function for all other placements of the set of placements.

In some aspects, translating the second shape within the first shape until the second shape is at the furthest point further comprises determining a first region comprising a first point along an edge of the first shape corresponding to an edge of the second shape extending beyond another edge of the first shape. In these aspects, the one or more processors may calculate a complement of the first region to determine a second region comprising a second point along the edge of the first shape corresponding to each edge of the second shape being contained within the first shape.

Further in these aspects, the one or more processors may iteratively determine a respective first region for each respective edge of the first shape, and may iteratively calculate a respective complement of each respective first region to determine a respective second region for each respective edge of the first shape. The one or more processors may also calculate a respective value of an objective function for each point included in each respective second region, and determine the furthest point based on a respective point in a respective second region that corresponds to a maximum respective value of the objective function relative to all other respective values of the objective function for all other respective points in all respective second regions.

In certain aspects, each edge of the second shape has a first respective vertex and a second respective vertex. In these aspects, translating the second shape within the first shape until the second shape is at the furthest point further comprises determining, by the one or more processors, a first region corresponding to a vertex of the first shape by sequentially translating the second shape from the first respective vertex to the second respective vertex of each edge of the second shape along the vertex of the first shape. The first region may comprise a point along a respective edge of the second shape corresponding to a respective edge of the second shape extending beyond an edge of the first shape. The one or more processors may calculate a complement of the first region to determine a second region comprising a point along a respective edge of the second shape corresponding to each edge of the second shape being contained within the first shape.

In some aspects, the one or more processors may generate a segment Voronoi diagram corresponding to the first shape that includes a Voronoi edge. The one or more processors may determine an extremity of the segment Voronoi diagram based on a point on the Voronoi edge where an edge of the second shape contacts an edge of the first shape. Moreover, the furthest point may correspond to the extremity. Further in these aspects, the extremity is a plurality of extremities, and the method 900 further comprises calculating, by the one or more processors, a respective projection of each extremity onto the input direction. The one or more processors may also determine a maximum extremity that corresponds to the furthest point based on a respective extremity that has a maximum respective projection relative to all other respective extremities.

In certain aspects, the first shape exists in a plane with a pair of orthogonal axes, and the second shape is an axis-parallel shape relative to the pair of orthogonal axes such that translating the axis-parallel shape within the first shape does not change an orientation of the edges of the axis-parallel shape relative to the pair of orthogonal axes.

In some aspects, the second shape is representative of a first information display, and the furthest point is a first furthest point. Further in these aspects, the method 900 further comprises, responsive to translating the second shape within the first shape until the second shape is at the first furthest point, designating, by the one or more processors, a first area of the second shape corresponding to the first furthest point. The one or more processors may also generate a third shape that is representative of a second information display, and translate the third shape within the first shape until the third shape is at a second furthest point relative to the input direction that is within the first shape. At the second furthest point, all edges of the third shape are contained within the first shape, and the second furthest point is not included within the first area. The one or more processors may also render the second information display at the second furthest point within the available display area.

At block 910, the one or more processors may render the information display at the furthest point within the available display area. In certain aspects, the one or more processors may obtain updated dimensions of the available display area, wherein the updated dimensions are different from the dimensions. The one or more processors may also determine an updated first shape representative of the available display area based on the updated dimensions, and translate the second shape within the updated first shape until the second shape is at a new furthest point relative to the input direction that is within the updated first shape. At the furthest point, all edges of the second shape are contained within the updated first shape. In these aspects, the one or more processors may also render the information display at the furthest point within the available display area.

In some aspects, the one or more processors may also obtain a new information display, and generate a new shape that is representative of the new information display. In these aspects, the one or more processors may also translate the new shape within the first shape until the new shape is at a new furthest point relative to the input direction that is within the first shape. At the new furthest point, all edges of the new shape are contained within the first shape, and the new furthest point is different from the furthest point. The one or more processors may also render the new information display at the new furthest point within the available display area. Additionally, in certain aspects, the one or more processors may resize and/or otherwise adjust the sizing and shape of the new shape representative of the new information display or any other shape representative of an information display at any point before, during, or after placement of the respective information display at the furthest point within the available display area.

In certain aspects, the second shape is representative of a first information display, the furthest point is a first furthest point, and the input direction is a first input direction. Further in these aspects, the method further comprises obtaining, at the one or more processors, a second input direction that is different from the first input direction. The one or more processors may also generate a third shape that is representative of a second information display, and translate the third shape within the first shape until the third shape is at a second furthest point relative to the second input direction that is within the first shape. At the second furthest point, all edges of the third shape are contained within the first shape, and the one or more processors may render the second information display at the second furthest point within the available display area.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 700, 800 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The methods 700, 800 may be included as part of any backend server (e.g., a map data server, a navigation server, or any other type of server computing device, as described herein), client computing device modules of the example environment, for example, or as part of a module that is external to such an environment. Though the figures may be described with reference to the other figures for case of explanation, the methods 700, 800 can be utilized with other objects and user interfaces. Furthermore, although the explanation above describes steps of the methods 700, 800 being performed by specific devices (such as a first computing device or a second computing device), this is done for illustration purposes only. The blocks of the methods 700, 800 may be performed by one or more devices or other parts of the environment.

### Aspects of the Present Disclosure

1. A method in a computing device for optimizing information display placement within display units, the method comprising: obtaining, by one or more processors of the computing device, dimensions of an available display area within a display unit that includes an input direction; determining, by the one or more processors, a first shape representative of the available display area based on the dimensions; generating, by the one or more processors, a second shape that is representative of an information display, wherein the second shape is smaller than the first shape; translating, by the one or more processors, the second shape within the first shape until the second shape is at a furthest point relative to the input direction that is within the first shape, wherein all edges of the second shape are contained within the first shape at the furthest point; and rendering, by the one or more processors, the information display at the furthest point within the available display area.

2. The method of aspect 1, wherein translating the second shape within the first shape until the second shape is at the furthest point further comprises: determining, by the one or more processors, a set of placements for the second shape within the first shape, wherein all edges of the second shape are contained within the first shape at each placement of the set of placements; calculating, by the one or more processors, a respective value of an objective function for each placement of the set of placements; and determining, by the one or more processors, the furthest point from the set of placements based on a respective placement of the set of placements that corresponds to a maximum respective value of the objective function relative to the respective value of the objective function for all other placements of the set of placements.

3. The method of any of aspects 1-2, wherein translating the second shape within the first shape until the second shape is at the furthest point further comprises: determining, by the one or more processors, a first region comprising a first point along an edge of the first shape corresponding to an edge of the second shape extending beyond another edge of the first shape; and calculating, by the one or more processors, a complement of the first region to determine a second region comprising a second point along the edge of the first shape corresponding to each edge of the second shape being contained within the first shape.

4. The method of aspect 3, further comprising: iteratively determining, by the one or more processors, a respective first region for each respective edge of the first shape; iteratively calculating, by the one or more processors, a respective complement of each respective first region to determine a respective second region for each respective edge of the first shape; calculating, by the one or more processors, a respective value of an objective function for each point included in each respective second region; and determining, by the one or more processors, the furthest point based on a respective point in a respective second region that corresponds to a maximum respective value of the objective function relative to all other respective values of the objective function for all other respective points in all respective second regions.

5. The method of any of aspects 1-4, wherein the method further comprises: obtaining, by the one or more processors, a two-dimensional (2D) input vector that includes the input direction; and translating, by the one or more processors, the second shape within the first shape until the second shape is at the furthest point relative to the input direction that is within the first shape.

6. The method of any of aspects 1-5, wherein each edge of the second shape has a first respective vertex and a second respective vertex, and translating the second shape within the first shape until the second shape is at the furthest point further comprises: determining, by the one or more processors, a first region corresponding to a vertex of the first shape by sequentially translating the second shape from the first respective vertex to the second respective vertex of each edge of the second shape along the vertex of the first shape, wherein the first region comprises a point along a respective edge of the second shape corresponding to a respective edge of the second shape extending beyond an edge of the first shape; and calculating, by the one or more processors, a complement of the first region to determine a second region comprising a point along a respective edge of the second shape corresponding to each edge of the second shape being contained within the first shape.

7. The method of any of aspects 1-6, further comprising: obtaining, by the one or more processors, updated dimensions of the available display area, wherein the updated dimensions are different from the dimensions; determining, by the one or more processors, an updated first shape representative of the available display area based on the updated dimensions; translating, by the one or more processors, the second shape within the updated first shape until the second shape is at a new furthest point relative to the input direction that is within the updated first shape, wherein all edges of the second shape are contained within the updated first shape at the furthest point; and rendering, by the one or more processors, the information display at the furthest point within the available display area.

8. The method of any of aspects 1-7, further comprising: generating, by the one or more processors, a segment Voronoi diagram corresponding to the first shape that includes a Voronoi edge; determining, by the one or more processors, an extremity of the segment Voronoi diagram based on a point on the Voronoi edge where an edge of the second shape contacts an edge of the first shape; and wherein the furthest point corresponds to the extremity.

9. The method of aspect 8, wherein the extremity is a plurality of extremities, and the method further comprises: calculating, by the one or more processors, a respective projection of each extremity onto the input direction; determining, by the one or more processors, a maximum extremity that corresponds to the furthest point based on a respective extremity that has a maximum respective projection relative to all other respective extremities.

10. The method of any of aspects 1-9, wherein the first shape exists in a plane with a pair of orthogonal axes, and the second shape is an axis-parallel shape relative to the pair of orthogonal axes such that translating the axis-parallel shape within the first shape does not change an orientation of the edges of the axis-parallel shape relative to the pair of orthogonal axes.

11. The method of any of aspects 1-10, wherein the second shape is representative of a first in-formation display, the furthest point is a first furthest point, and the method further comprises: responsive to translating the second shape within the first shape until the second shape is at the first furthest point, designating, by the one or more processors, a first area of the second shape corresponding to the first furthest point; generating, by the one or more processors, a third shape that is representative of a second information display; translating, by the one or more processors, the third shape within the first shape until the third shape is at a second furthest point relative to the input direction that is within the first shape, wherein all edges of the third shape are contained within the first shape at the second furthest point, and the second furthest point is not included within the first area; and rendering, by the one or more processors, the second information display at the second furthest point within the available display area.

12. The method of any of aspects 1-11, further comprising: obtaining, at the one or more processors, a new information display; generating, by the one or more processors, a new shape that is representative of the new information display; translating, by the one or more processors, the new shape within the first shape until the new shape is at a new furthest point relative to the input direction that is within the first shape, wherein all edges of the new shape are contained within the first shape at the new furthest point, and the new furthest point is different from the furthest point; and rendering, by the one or more processors, the new information display at the new furthest point within the available display area.

13. The method of any of aspects 1-12, wherein the second shape is representative of a first in-formation display, the furthest point is a first furthest point, the input direction is a first input direction, and the method further comprises: obtaining, at the one or more processors, a second input direction that is different from the first input direction; generating, by the one or more processors, a third shape that is representative of a second information display; translating, by the one or more processors, the third shape within the first shape until the third shape is at a second furthest point relative to the second input direction that is within the first shape, wherein all edges of the third shape are contained within the first shape at the second furthest point; and rendering, by the one or more processors, the second information display at the second furthest point within the available display area.

14. A computing device for optimizing information display placement within display units, the computing device comprising: one or more processors; and a computer-readable memory which is optionally non-transitory, coupled to the one or more processors and storing instructions thereon that, when executed by the one or more processors, cause the computing device to: obtain dimensions of an available display area within a display unit and an input direction, determine a first shape representative of the available display area based on the dimensions, generate a second shape that is representative of an information display, translate the second shape within the first shape until the second shape is at a furthest point relative to the input direction that is within the first shape, wherein all edges of the second shape are contained within the first shape at the furthest point, and render the information display at the furthest point within the available display area.

15. The computing device of aspect 14, wherein translating the second shape within the first shape until the second shape is at the furthest point further comprises: determining, by the one or more processors, a set of placements for the second shape within the first shape, wherein all edges of the second shape are contained within the first shape at each placement of the set of placements; calculating, by the one or more processors, a respective value of an objective function for each placement of the set of placements; and determining, by the one or more processors, the furthest point from the set of placements based on a respective placement of the set of placements that corresponds to a maximum respective value of the objective function relative to the respective value of the objective function for all other placements of the set of placements.

16. The computing device of any of aspects 14-15, wherein translating the second shape within the first shape until the second shape is at the furthest point further comprises: determining, by the one or more processors, a first region comprising a first point along an edge of the first shape corresponding to an edge of the second shape extending beyond another edge of the first shape; and calculating, by the one or more processors, a complement of the first region to determine a second region comprising a second point along the edge of the first shape corresponding to each edge of the second shape being contained within the first shape.

17. The computing device of any of aspects 14-16, further comprising: iteratively determining, by the one or more processors, a respective first region for each respective edge of the first shape; iteratively calculating, by the one or more processors, a respective complement of each respective first region to determine a respective second region for each respective edge of the first shape; calculating, by the one or more processors, a respective value of an objective function for each point included in each respective second region; and determining, by the one or more processors, the furthest point based on a respective point in a respective second region that corresponds to a maximum respective value of the objective function relative to all other respective values of the objective function for all other respective points in all respective second regions.

18. The computing device of any of aspects 14-17, wherein the method further comprises: obtaining, by the one or more processors, a two-dimensional (2D) input vector that includes the input direction; and translating, by the one or more processors, the second shape within the first shape until the second shape is at the furthest point relative to the input direction that is within the first shape.

19. The computing device of any of aspects 14-18, wherein each edge of the second shape has a first respective vertex and a second respective vertex, and translating the second shape within the first shape until the second shape is at the furthest point further comprises: determining, by the one or more processors, a first region corresponding to a vertex of the first shape by sequentially translating the second shape from the first respective vertex to the second respective vertex of each edge of the second shape along the vertex of the first shape, wherein the first region comprises a point along a respective edge of the second shape corresponding to a respective edge of the second shape extending beyond an edge of the first shape; and calculating, by the one or more processors, a complement of the first region to determine a second region comprising a point along a respective edge of the second shape corresponding to each edge of the second shape being contained within the first shape.

20. A method in a computing device for optimizing information display placement within display units, the method comprising: obtaining, by one or more processors of the computing device, dimensions of an available display area within a display unit, the available display area represented by an irregular shape; obtaining, by the one or more processors, an information display; placing, by the one or more processors, the information display within the available display area along a border of the irregular shape; and presenting, by the one or more processors, the information display within the available display area.

### Additional Considerations

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for optimizing information display placement within display units through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method in a computing device for optimizing data display placement within display units, the method comprising:
obtaining, by one or more processors of the computing device, dimensions of an available display area within a display unit;
determining, by the one or more processors, an irregular shape representative of the available display area based on the dimensions;
generating, by the one or more processors, a second shape that is representative of a data display, wherein the second shape is smaller than the irregular shape;
translating, by the one or more processors, the second shape within the irregular shape until the second shape is at a location within the irregular shape, wherein all edges of the second shape are contained within the irregular shape at the location; and
rendering, by the one or more processors, the data display at the location within the available display area.

2. The method of claim 1, wherein translating the second shape within the irregular shape until the second shape is at the furthest point further comprises:
determining, by the one or more processors, a set of placements for the second shape within the irregular shape, wherein all edges of the second shape are contained within the irregular shape at each placement of the set of placements;
calculating, by the one or more processors, a respective value of an objective function for each placement of the set of placements; and
determining, by the one or more processors, the location from the set of placements based on a respective placement of the set of placements that corresponds to a maximum respective value of the objective function relative to the respective value of the objective function for all other placements of the set of placements.

3. The method of claim 1, wherein translating the second shape within the irregular shape until the second shape is at the location further comprises:
determining, by the one or more processors, a first region comprising a first point along an edge of the irregular shape corresponding to an edge of the second shape extending beyond another edge of the irregular shape; and
calculating, by the one or more processors, a complement of the first region to determine a second region comprising a second point along the edge of the irregular shape corresponding to each edge of the second shape being contained within the irregular shape.

4. The method of claim 3, further comprising:
iteratively determining, by the one or more processors, a respective first region for each respective edge of the irregular shape;
iteratively calculating, by the one or more processors, a respective complement of each respective first region to determine a respective second region for each respective edge of the irregular shape;
calculating, by the one or more processors, a respective value of an objective function for each point included in each respective second region; and
determining, by the one or more processors, the furthest point based on a respective point in a respective second region that corresponds to a maximum respective value of the objective function relative to all other respective values of the objective function for all other respective points in all respective second regions.

5. The method of claim 1, wherein the method further comprises:
obtaining, by the one or more processors, a two-dimensional (2D) input vector that includes an input direction; and
translating, by the one or more processors, the second shape within the irregular shape until the second shape is at the location within the irregular shape, wherein the location is a furthest point relative to the input direction that is within the irregular shape.

6. The method of claim 1, wherein each edge of the second shape has a first respective vertex and a second respective vertex, and translating the second shape within the irregular shape until the second shape is at the furthest point further comprises:
determining, by the one or more processors, a first region corresponding to a vertex of the irregular shape by sequentially translating the second shape from the first respective vertex to the second respective vertex of each edge of the second shape along the vertex of the irregular shape, wherein the first region comprises a point along a respective edge of the second shape corresponding to a respective edge of the second shape extending beyond an edge of the irregular shape; and
calculating, by the one or more processors, a complement of the first region to determine a second region comprising a point along a respective edge of the second shape corresponding to each edge of the second shape being contained within the irregular shape.

7. The method of claim 1, further comprising:
obtaining, by the one or more processors, updated dimensions of the available display area, wherein the updated dimensions are different from the dimensions;
determining, by the one or more processors, an updated irregular shape representative of the available display area based on the updated dimensions;
translating, by the one or more processors, the second shape within the updated irregular shape until the second shape is at a new location within the updated irregular shape, wherein all edges of the second shape are contained within the updated irregular shape at the new location; and
rendering, by the one or more processors, the data display at the new location within the available display area.

8. The method of claim 1, further comprising:
generating, by the one or more processors, a segment Voronoi diagram corresponding to the irregular shape that includes a Voronoi edge;
determining, by the one or more processors, an extremity of the segment Voronoi diagram based on a point on the Voronoi edge where an edge of the second shape contacts an edge of the irregular shape; and
wherein the location corresponds to the extremity.

9. The method of claim 8, wherein the extremity is a plurality of extremities, and the method further comprises:
calculating, by the one or more processors, a respective projection of each extremity onto an input direction;
determining, by the one or more processors, a maximum extremity that corresponds to the location based on a respective extremity that has a maximum respective projection relative to all other respective extremities.

10. The method of claim 1, wherein the irregular shape exists in a plane with a pair of orthogonal axes, and the second shape is an axis-parallel shape relative to the pair of orthogonal axes such that translating the axis-parallel shape within the irregular shape does not change an orientation of the edges of the axis-parallel shape relative to the pair of orthogonal axes.

11. The method of claim 1, wherein the second shape is representative of a first data display, the location is a first location, and the method further comprises:
responsive to translating the second shape within the irregular shape until the second shape is at the first location, designating, by the one or more processors, a first area of the second shape corresponding to the first location;
generating, by the one or more processors, a third shape that is representative of a second data display;
translating, by the one or more processors, the third shape within the irregular shape until the third shape is at a second location within the irregular shape, wherein all edges of the third shape are contained within the irregular shape at the second location, and the second furthest point is not included within the first area; and
rendering, by the one or more processors, the second data display at the second location within the available display area.

12. The method of claim 1, further comprising:
obtaining, at the one or more processors, a new data display;
generating, by the one or more processors, a new shape that is representative of the new data display;
translating, by the one or more processors, the new shape within the irregular shape until the new shape is at a new location within the irregular shape, wherein all edges of the new shape are contained within the irregular shape at the new location, and the new location is different from the location; and
rendering, by the one or more processors, the new data display at the new location within the available display area.

13. The method of claim 5, wherein the second shape is representative of a first data display, the furthest point is a first furthest point, the input direction is a first input direction, and the method further comprises:
obtaining, at the one or more processors, a second input direction that is different from the first input direction;
generating, by the one or more processors, a third shape that is representative of a second data display;
translating, by the one or more processors, the third shape within the first shape until the third shape is at a second furthest point relative to the second input direction that is within the irregular shape, wherein all edges of the third shape are contained within the irregular shape at the second furthest point; and
rendering, by the one or more processors, the second data display at the second furthest point within the available display area.

14. A computing device for optimizing data display placement within display units, the computing device comprising:
one or more processors; and
a computer-readable memory coupled to the one or more processors and storing instructions thereon that, when executed by the one or more processors, cause the computing device to:
obtain dimensions of an available display area within a display unit,
determine an irregular shape representative of the available display area based on the dimensions,
generate a second shape that is representative of a data display,
translate the second shape within the irregular shape until the second shape is at a location within the irregular shape, wherein all edges of the second shape are contained within the irregular shape at the location, and
render the data display at the location within the available display area.

15. The computing device of claim 14, wherein the instructions, when executed by the one or more processors, further cause the computing device to:
determine a set of placements for the second shape within the irregular shape, wherein all edges of the second shape are contained within the irregular shape at each placement of the set of placements;
calculate a respective value of an objective function for each placement of the set of placements; and
determine the location from the set of placements based on a respective placement of the set of placements that corresponds to a maximum respective value of the objective function relative to the respective value of the objective function for all other placements of the set of placements.

16. The computing device of claim 14, wherein the instructions, when executed by the one or more processors, further cause the computing device to:
determine a first region comprising a first point along an edge of the irregular shape corresponding to an edge of the second shape extending beyond another edge of the irregular shape; and
calculate a complement of the first region to determine a second region comprising a second point along the edge of the irregular shape corresponding to each edge of the second shape being contained within the irregular shape.

17. The computing device of claim 16, wherein the instructions, when executed by the one or more processors, further cause the computing device to:
iteratively determine a respective first region for each respective edge of the irregular shape;
iteratively calculate a respective complement of each respective first region to determine a respective second region for each respective edge of the irregular shape;
calculate a respective value of an objective function for each point included in each respective second region; and
determine the location based on a respective point in a respective second region that corresponds to a maximum respective value of the objective function relative to all other respective values of the objective function for all other respective points in all respective second regions.

18. The computing device of claim 14, wherein the instructions, when executed by the one or more processors, further cause the computing device to:
obtain a two-dimensional (2D) input vector that includes an input direction; and
translate the second shape within the irregular shape until the second shape is at the location within the irregular shape, wherein the location is a furthest point relative to the input direction.

19. The computing device of claim 14, wherein each edge of the second shape has a first respective vertex and a second respective vertex, and the instructions, when executed by the one or more processors, further cause the computing device to:
determine a first region corresponding to a vertex of the irregular shape by sequentially translating the second shape from the first respective vertex to the second respective vertex of each edge of the second shape along the vertex of the irregular shape, wherein the first region comprises a point along a respective edge of the second shape corresponding to a respective edge of the second shape extending beyond an edge of the irregular shape; and
calculate a complement of the first region to determine a second region comprising a point along a respective edge of the second shape corresponding to each edge of the second shape being contained within the irregular shape.

20. The computing device of claim 14, wherein the instructions, when executed by the one or more processors, further cause the computing device to:
obtain a new data display;
generate a new shape that is representative of the new data display;
translate the new shape within the irregular shape until the new shape is at a new location within the irregular shape, wherein all edges of the new shape are contained within the irregular shape at the new location, and the new location is different from the location; and
render the new data display at the new location within the available display area.
